(19) United States
(12) Patent Application Publication
(10) Pub. No.: US 2020/0304820 A1
(43) Pub. Date: Sep. 24, 2020

(54) METHOD AND APPARATUS FOR EMPLOYING PATTERNS IN SAMPLE METADATA SIGNALLING IN MEDIA CONTENT

(71) Applicant: Nokia Technologies Oy, Espoo (FI)

(72) Inventors: Miska Matias HANNUKSELA, Tampere (FI); Emre Baris AKSU, Tampere (FI); Kashyap KAMMACHI-SREEDHAR, Tampere (FI)

(73) Assignee: Nokia Technologies Oy, Espoo (FI)

(21) Appl. No.: 16/823,459

(22) Filed: Mar. 19, 2020

Related U.S. Application Data
(60) Provisional application No. 62/821,260, filed on Mar. 20, 2019.

(51) Int. Cl. H04N 19/46; H04N 19/172; H04N 19/132

(52) U.S. Cl. CPC H04N 19/46; H04N 19/132; H04N 19/172

(57) ABSTRACT

A method, apparatus and computer program product encode, into a container file comprising one or more samples, track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run.

### CROSS-REFERENCE TO RELATED APPLICATION

This patent application claims priority from U.S. Provisional Patent Application Ser. No. 62/821,260, titled “METHOD AND APPARATUS FOR EMPLOYING PATTERNS IN SAMPLE METADATA SIGNALLING IN MEDIA CONTENT,” filed Mar. 20, 2019, which is incorporated herein by reference in its entirety.

### TECHNICAL FIELD

An example embodiment relates generally to video encoding and decoding.

### BACKGROUND

A media container file format is an element in the chain of media content production, manipulation, transmission and consumption. In this context, the coding format (e.g., the elementary stream format) relates to the action of a specific coding algorithm that codes the content information into a bitstream. The container file format comprises mechanisms for organizing the generated bitstream in such a way that it can be accessed for local decoding and playback, transferring as a file, or streaming, all utilizing a variety of storage and transport architectures. The container file format can also facilitate the interchanging and editing of the media, as well as the recording of received real-time streams to a file.

In a container file according to ISO base media file format (ISOBMFF; ISO/IEC 14496-12), the media data and metadata is arranged in various types of boxes. ISOBMFF provides a movie fragment feature that may enable splitting the metadata that otherwise might reside in a movie box into multiple pieces. Consequently, the size of the movie box may be limited in order to avoid losing data if any unwanted incident occurs.

In container files, it is also possible to use extractors, which may be defined as structures that are stored in samples and extract coded video data from other tracks by reference when processing the track in a player. Extractors enable compact formation of tracks that extract coded video data by reference.

However, upon using the movie fragment feature or extractors, the overhead of the metadata or extractor tracks may become significant compared to the payload.

### BRIEF SUMMARY

A method, apparatus and computer program product are provided in accordance with an example embodiment to provide a mechanism for encoding metadata in media content. The method, apparatus and computer program product may be utilized in conjunction with a variety of video formats.

In one example embodiment, a method is provided that includes encoding, into a container file comprising one or more samples, track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The method further includes causing storage of the container file. In some embodiments, the encoding further includes encoding a subset of one or more per-sample metadata fields as set by cyclic assignment of the pattern.

In another example embodiment, a method is provided that includes receiving a container file comprising one or more samples and a track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The method further includes parsing the track fragment run metadata into per-sample metadata for the one or more samples. In some embodiments, the parsing further includes parsing a subset of one or more per-sample metadata fields as set by cyclic assignment of the pattern.

In another example embodiment, an apparatus is provided that includes means for encoding, into a container file comprising one or more samples, track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The apparatus further includes means for causing storage of the container file. In some embodiments, the means for encoding further includes means for encoding a subset of one or more per-sample metadata fields as set by cyclic assignment of the pattern.

In another example embodiment, an apparatus is provided that includes means for receiving a container file comprising one or more samples and a track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The apparatus further includes means for parsing the track fragment run metadata into per-sample metadata for the one or more samples. In some embodiments, the means for parsing further includes means for parsing a subset of one or more per-sample metadata fields as set by cyclic assignment of the pattern.

In another example embodiment, an apparatus is provided that includes processing circuitry and at least one memory including computer program code for one or more programs with the at least one memory and the computer program code configured to, with the processing circuitry, cause the apparatus at least to encode, into a container file comprising one or more samples, track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The computer program code is further configured to, with the at least one processor, cause the apparatus to cause storage of the container file. In some embodiments, the encoding further includes encoding a subset of one or more per-sample metadata fields as set by cyclic assignment of the pattern.

In another example embodiment, an apparatus is provided that includes processing circuitry and at least one memory including computer program code for one or more programs with the at least one memory and the computer program code configured to, with the processing circuitry, cause the apparatus at least to receive a container file comprising one or more samples and a track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The computer program code is further configured to, with the at least one processor, cause the apparatus to parse the track fragment run metadata into per-sample metadata for the one or more samples. In some embodiments, the parsing further includes parsing a subset of one or more per-sample metadata fields as set by cyclic assignment of the pattern.

In another example embodiment, a computer program product is provided that includes at least one non-transitory computer-readable storage medium having computer executable program code instructions stored therein with the computer executable program code instructions comprising program code instructions configured, upon execution, to encode, into a container file comprising one or more samples, track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The computer executable program code instructions comprise program code instructions that are further configured, upon execution, to cause storage of the container file. In some embodiments, the encoding further includes encoding a subset of one or more per-sample metadata fields as set by cyclic assignment of the pattern.

In another example embodiment, a computer program product is provided that includes at least one non-transitory computer-readable storage medium having computer executable program code instructions stored therein with the computer executable program code instructions comprising program code instructions configured, upon execution, to receive a container file comprising one or more samples and a track fragment run metadata associated with a track fragment run. The track fragment run metadata includes a per-sample part comprising per-sample metadata for one or more samples in the container file and a cyclic part. The track fragment run metadata includes an indication of a pattern appearing earlier in the track fragment run and resolving the cyclic part causes at least a subset of the per-sample part to be set by cyclic assignment of the pattern indication of a pattern appearing earlier in the track fragment run. The computer executable program code instructions comprise program code instructions that are further configured, upon execution, to parse the track fragment run metadata into per-sample metadata for the one or more samples. In some embodiments, the parsing further includes parsing a subset of one or more per-sample metadata fields as set by cyclic assignment of the pattern.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with an example embodiment of the present disclosure;

FIG. 2 is a flowchart illustrating a set of operations performed, such as by the apparatus of FIG. 1, in accordance with an example embodiment of the present disclosure; and

FIG. 3 is a flowchart illustrating a set of operations performed, such as by the apparatus of FIG. 1, in accordance with an example embodiment of the present disclosure.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal. The terms “tile” and “sub-picture” may be used interchangeably.

A method, apparatus and computer program product are provided in accordance with an example embodiment to provide a mechanism for encoding metadata in media content. The method, apparatus and computer program product may be utilized in conjunction with a variety of video formats including High Efficiency Video Coding standard (HEVC or H.265/HEVC), Advanced Video Coding standard (AVC or H.264/AVC), the upcoming Versatile Video Coding standard (VVC or H.266/VVC), and/or with a variety of video and multimedia file formats including International Standards Organization (ISO) base media file format (ISO/IEC 14496-12, which may be abbreviated as ISOBMFF), Moving Picture Experts Group (MPEG)-4 file format (ISO/IEC 14496-14, also known as the MP4 format), and file formats for NAL (Network Abstraction Layer) unit structured video (ISO/IEC 14496-15) and 3^{rd} Generation Partnership Project (3GPP file format) (3GPP Technical Specification 26.244, also known as the 3GP format). ISOBMFF is the base for derivation of all the above mentioned file formats. An example embodiment is described in conjunction with HEVC and ISOBMFF, however, the present disclosure is not limited to HEVC or ISOBMFF, but rather the description is given for one possible basis on top of which an example embodiment of the present disclosure may be partly or fully realized.

Some aspects of the disclosure relate to container file formats, such as International Standards Organization (ISO) base media file format (ISO/IEC 14496-12, which may be abbreviated as ISOBMFF), Moving Picture Experts Group (MPEG)-4 file format (ISO/IEC 14496-14, also known as the MP4 format), and file formats for NAL (Network Abstraction Layer) unit structured video (ISO/IEC 14496-15) and 3^{rd} Generation Partnership Project (3GPP file format) (3GPP Technical Specification 26.244, also known as the 3GP format). An example embodiment may be described in conjunction with the MPEG or its derivatives, however, the present disclosure is not limited to the MPEG, but rather the description is given for one possible basis on top of which an example embodiment of the present disclosure may be partly or fully realized.

Regardless of the file format of the video bitstream, the apparatus of an example embodiment may be provided by any of a wide variety of computing devices including, for example, a video encoder, a video decoder, a computer workstation, a server or the like, or by any of various mobile computing devices, such as a mobile terminal, e.g., a smartphone, a tablet computer, a video game player, or the like.

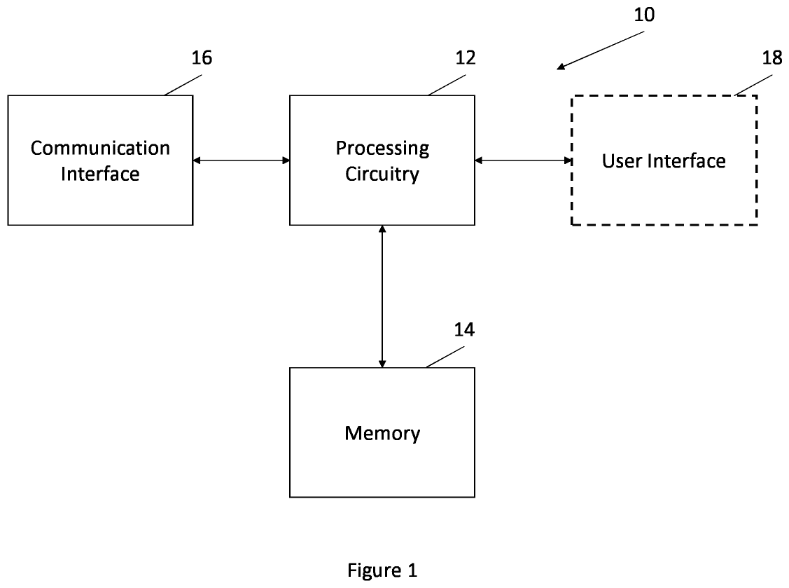

Regardless of the computing device that embodies the apparatus, the apparatus 10 of an example embodiment includes, is associated with or is otherwise in communication with processing circuitry 12, a memory 14, a communication interface 16 and optionally, a user interface 18 as shown in FIG. 1.

The processing circuitry 12 may be in communication with the memory device 14 via a bus for passing information among components of the apparatus 10. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 10 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processing circuitry 12 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In some embodiments, the processing circuitry 12 may be configured to execute instructions stored in the memory device 14 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment of the present disclosure by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 16 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, such as in instances in which the apparatus 10 is configured to encode the video bitstream, the apparatus 10 may optionally include a user interface 18 that may, in turn, be in communication with the processing circuitry 12 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device 14, and/or the like).

When describing certain example embodiments, the term file is sometimes used as a synonym of syntax structure or an instance of a syntax structure. In other contexts, the term file may be used to mean a computer file, that is a resource forming a standalone unit in storage.

When describing various syntax and in certain example embodiments, a syntax structure may be specified as described below. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice may include an integer number of macroblocks ordered consecutively in the raster scan within a particular slice group.

When describing the operation of video encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples.

In some video codecs, such as a High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size may be named as the LCU (largest coding unit) or coding tree unit (CTU) and the video picture is divided into non-overlapping LCUs. An LCU can be further split into a combination of smaller CUs, e.g., by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g., motion vector information for inter predicted PUs and intra prediction directionality information for intra predicted PUs).

Images can be split into independently codable and decodable image segments (e.g., slices or tiles or tile groups), which may also be referred to as independently coded picture regions. Such image segments may enable parallel processing, “Slices” in this description may refer to image segments constructed of a certain number of basic coding units that are processed in default coding or decoding order, while “tiles” may refer to image segments that have been defined as rectangular image regions. A tile group may be defined as a group of one or more tiles. Image segments may be coded as separate units in the bitstream, such as VCL NAL units in H.264/AVC and HEVC. Coded image segments may comprise a header and a payload, wherein the header contains parameter values needed for decoding the payload.

Each TU can be associated with information describing the prediction error decoding process for the samples within the TU (including, e.g., discrete cosine transform coefficient information). It is typically signalled at a CU level whether prediction error coding is applied or not for each CU. In the case there is no prediction error residual associated with the CU, it can be considered that there are no TUs for the CU. The division of the image into CUs, and division of CUs into PUs and TUs is typically signalled in the bitstream allowing the decoder to reproduce the intended structure of these units.

In the HEVC standard, a picture can be partitioned in tiles, which are rectangular and contain an integer number of CTUs. In the HEVC standard, the partitioning to tiles forms a grid that may be characterized by a list of tile column widths (in CTUs) and a list of tile row heights (in CTUs). Tiles are ordered in the bitstream consecutively in the raster scan order of the tile grid. A tile may contain an integer number of slices.

In the HEVC, a slice may include an integer number of CTUs. The CTUs are scanned in the raster scan order of CTUs within tiles or within a picture, if tiles are not in use. A slice may contain an integer number of tiles and a slice can be contained in a tile. Within a CTU, the CUs have a specific defined scan order.

In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single Network Abstraction Layer (NAL) unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

In a draft version of H.266/VVC, pictures are partitioned to tiles along a tile grid (similarly to HEVC). Two types of tile groups are specified, namely raster-scan-order tile groups and rectangular tile groups, and an encoder may indicate in the bitstream, e.g., in a picture parameter set (PPS), which type of a tile group is being used. In raster-scan-order tile groups, tiles are ordered in the bitstream in tile raster scan order within a picture, and CTUs are ordered in the bitstream in raster scan order within a tile. In rectangular tile groups, a picture is partitioned into rectangular tile groups, and tiles are ordered in the bitstream in raster scan order within each tile group, and CTUs are ordered in the bitstream in raster scan order within a tile. Regardless of the tile group type, a tile group contains one or more entire tiles in bitstream order, and a VCL NAL unit contains one tile group.

An elementary unit for the output of an H.264/advanced video coding (AVC) or HEVC encoder and the input of an H.264/AVC or HEVC decoder, respectively, is a NAL unit. For transport over packet-oriented networks or storage into structured files, NAL units may be encapsulated into packets or similar structures. In ISO base media file format, NAL units of an access unit form a sample, the size of which is provided within the file format metadata.

A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of a raw byte sequence payload (RBSP) interspersed as necessary with emulation prevention bytes. A RBSP may be defined as a syntax structure containing an integer number of bytes that is encapsulated in a NAL unit.

When describing an example embodiment related to HEVC and VVC, the following description may be used to specify the parsing process of each syntax element: 1) u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with the most significant bit written first. 2) ue(v): unsigned integer Exponential-Golomb-coded syntax element with the left bit first.

A bitstream may be defined as a sequence of bits, which may in some coding formats or standards be in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of bitstream (EOB) NAL unit and which is the last NAL unit of the bitstream.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or the like may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Video coding specifications may contain a set of constraints for associating data units (e.g., NAL units in H.264/AVC or HEVC) into access units. These constraints may be used to conclude access unit boundaries from a sequence of NAL units. For example, the following is specified in the HEVC standard:
An access unit consists of one coded picture with nuh_layer_id equal to 0, zero or more VCL NAL units with nuh_layer_id greater than 0 and zero or more non-VCL NAL units.
The firstBlPicNalUnit is the first VCL NAL unit of a coded picture with nuh_layer_id equal to 0. The first of any of the following NAL units preceding firstBlPicNalUnit and succeeding the last VCL NAL unit preceding firstBlPicNalUnit, if any, specifies the start of a new access unit:
   access unit delimiter NAL unit with nuh_layer_id equal to 0 (when present),
   VPS NAL unit with nuh_layer_id equal to 0 (when present),
   SPS NAL unit with nuh_layer_id equal to 0 (when present),
   PPS NAL unit with nuh_layer_id equal to 0 (when present),
   Prefix SEI NAL unit with nuh_layer_id equal to 0 (when present),
   NAL units with nal_unit_type in the range of RSV_NVCL41 . . . RSV_NVCL44 with nuh_layer_id equal to 0 (when present),
   NAL units with nal_unit_type in the range of UNSPEC48 . . . UNSPEC55 with nuh_layer_id equal to 0 (when present).
The first NAL unit preceding firstBlPicNalUnit and succeeding the last VCL NAL unit preceding firstBlPicNalUnit, if any, can only be one of the above-listed NAL units.
When there is none of the above NAL units preceding firstBlPicNalUnit and succeeding the last VCL NAL preceding firstBlPicNalUnit, if any, firstBlPicNalUnit starts a new access unit.

Some concepts, structures, and specifications of ISOBMFF are described below as an example of a container file format, based on which the certain embodiments may be implemented. Certain example embodiments are not limited to ISOBMFF, but rather the description is given for one possible basis on top of which certain embodiments may be partly or fully realized.

A basic building block in the ISO base media file format is called a box. Each box has a header and a payload. The box header indicates the type of the box and the size of the box in terms of bytes. A box may enclose other boxes, and ISOBMFF specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISOBMFF, a file includes media data and metadata that are encapsulated into boxes. Each box is identified by a four character code (4CC) and starts with a header which informs about the type and size of the box.

In files conforming to the ISO base media file format, the media data may be provided in a media data ‘mdat’ box (a.k.a. MediaDataBox) and the movie ‘moov’ box (a.k.a. MovieBox) may be used to enclose the metadata. In some cases, for a file to be operable, both of the ‘mdat’ and ‘moov’ boxes may be required to be present. The movie ‘moov’ box may include one or more tracks, and each track may reside in one corresponding TrackBox (‘trak’). A track may be one of the many types, including a media track that refers to samples formatted according to a media compression format (and its encapsulation to the ISO base media file format). A track may be regarded as a logical channel.

Movie fragments may be used, e.g., for streaming delivery or progressive downloading of media content, or when recording content to ISOBMFF files e.g., in order to avoid losing data if a recording application crashes, runs out of memory space, or some other incident occurs. Without movie fragments, data loss may occur because the file format may require that all metadata, e.g., the movie box, be written in one contiguous area of the file. Furthermore, when recording a file, there may not be sufficient amount of memory space (e.g., random access memory RAM) to buffer a movie box for the size of the storage available, and re-computing the contents of a movie box when the movie is closed may be too slow. Moreover, movie fragments may enable simultaneous recording and playback of a file using a regular ISOBMFF file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box, if they are in the same file as the moov box. For the metadata of the movie fragments, however, a moof box may be provided. The moof box may include the information for a certain duration of playback time that would previously have been in the moov box. The moov box may still represent a valid movie on its own, but in addition, it may include an mvex box (a.k.a. MovieExtendsBox) indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs (a.k.a. track fragment runs), each of which document is a contiguous run of samples for that track. Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISO base media file format specification.

A movie fragment comprises of one or more track fragments per track, each described by TrackFragmentBox. The TrackFragmentHeaderBox within the movie fragment sets up information and defaults used for track runs of samples. The syntax of the TrackFragmentHeader in ISOBMFF is provided below:

aligned(8) class TrackFragmentHeaderBox

extends FullBox(‘tfhd’, 0, tf_flags){

unsigned int(32) track_ID;
// all the following are optional fields
// their presence is indicated by bits in the tf_flags
unsigned int(64) base_data_offset;
unsigned int(32) sample _description_index;
unsigned int(32) default_sample_duration;
unsigned int(32) default_sample_size;
unsigned int(32) default_sample_flags;

}

The following flags are defined in the tf_flags:
0x000001 base-data-offset-present: indicates the presence of the base-data-offset field. This provides an explicit anchor for the data offsets in each track run (see below). If not provided and if the default-base-is-moof flag is not set, the base-data-offset for the first track in the movie fragment is the position of the first byte of the enclosing MovieFragmentBox, and for second and subsequent track fragments, the default is the end of the data defined by the preceding track fragment. Fragments ‘inheriting’ their offset in this way must all use the same data-reference (e.g., the data for these tracks must be in the same file)
0x000002 sample-description-index-present: indicates the presence of this field, which over-rides, in this fragment, the default set up in the TrackExtendsBox.
0x000008 default-sample-duration-present
0x000010 default-sample-size-present
0x000020 default-sample-flags-present
0x010000 duration-is-empty: this indicates that the duration provided in either default-sample-duration, or by the default-sample-duration in the TrackExtendsBox, is empty, e.g., that there are no samples for this time interval. It is an error to make a presentation that has both edit lists in the MovieBox, and empty-duration fragments.
0x020000 default-base-is-moof: if base-data-offset-present is 1, this flag is ignored. If base-data-offset-present is zero, this indicates that the base-data-offset for this track fragment is the position of the first byte of the enclosing MovieFragmentBox. Support for the default-base-is-moof flag is required under the ‘iso5’ brand, and it may not be used in brands or compatible brands earlier than ‘iso5’.

A track fragment comprises one or more track fragment runs (a.k.a. track runs), each described by TrackRunBox. A track run documents a contiguous set of samples for a track, which is also a contiguous range of bytes of media data.

The syntax of the TrackRunBox in ISOBMFF is provided below:

aligned(8) class TrackRunBox

extends FullBox(‘trun’, version, tr_flags) {

unsigned int(32) sample_count;
// the following are optional fields
signed int(32) data_offset;
unsigned int(32) first_sample_flags;
// all fields in the following array are optional
// as indicated by bits set in the tr_flags
{

unsigned int(32) sample_duration;
unsigned int(32) sample_size;
unsigned int(32) sample_flags
if (version == 0)

{ unsigned int(32) sample_composition_time_offset; }

else

{ signed int(32)
sample_composition_time_offset; }

( [sample_count ]

}

The presence of the optional fields is controlled by the values of tr_flags provided below:
0x000001 data-offset-present.
0x000004 first-sample-flags-present; this over-rides the default flags for the first sample only. This makes it possible to record a group of frames where the first is a key and the rest are difference frames, without supplying explicit flags for every sample. If this flag and field are used, sample-flags-present is required to be set equal to 0.
0x000100 sample-duration-present: indicates that each sample has its own duration, otherwise the default is used.
0x000200 sample-size-present: each sample has its own size, otherwise the default is used.
0x000400 sample-flags-present; each sample has its own flags, otherwise the default is used.
0x000800 sample-composition-time-offsets-present; each sample has a composition time offset (e.g., as used for I/P/B video in MPEG).

A self-contained movie fragment may be defined to consist of a moof box and an mdat box that are consecutive in the file order and where the mdat box contains the samples of the movie fragment (for which the moof box provides the metadata) and does not contain samples of any other movie fragment (e.g., any other moof box).

A media segment may comprise one or more self-contained movie fragments. A media segment may be used for delivery, such as streaming, e.g., in MPEG-DASH (Dynamic Adaptive Streaming over Hypertext Transfer Protocol (HTTP)).

The track reference mechanism can be used to associate tracks with each other. The TrackReferenceBox includes box(es), each of which provides a reference from the containing track to a set of other tracks. These references are labeled through the box type (e.g., the four-character code of the box) of the contained box(es).

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the SVC file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g., to indicate a sub-type of the grouping.

Byte count of file format samples of tile/sub-picture tracks can be very small, just few tens of bytes, when a fine tile grid is used. The overhead of file format metadata for movie fragments, most notably TrackRunBox can be significant. For example, when hierarchical inter prediction is used in video tracks, both sample_size and sample_composition_time_offset are present in TrackRunBox, and thus the TrackRunBox occupies at least 8 bytes per sample.

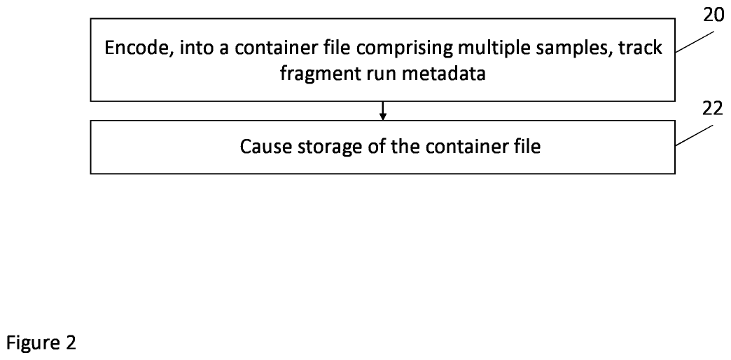

FIG. 2 illustrates the process of encoding track fragment run metadata performed by, for example, a file writer, an encoder, or the like that may be embodied by apparatus 10 of FIG. 1. As illustrated in block 20, an apparatus, such as apparatus 10 of FIG. 1, includes means, such as the processing circuitry 12, for encoding, into a container file comprising multiple samples, a track fragment run metadata. The track fragment run metadata includes a per-sample part comprising per-sample metadata for each sample in the container file and a cyclic part. The track fragment run metadata further comprises indication of a pattern appearing earlier in the track fragment run and resolving the cyclic part causes at least a subset of the per-sample part to be set by cyclic assignment of the pattern indication of a pattern appearing earlier in the track fragment run. The track fragment run metadata may be generated by the apparatus. Details regarding the track fragment run metadata are described later in this disclosure.

As illustrated in block 22, an apparatus, such as apparatus 10 of FIG. 1, includes means, such as the processing circuitry 12 and the memory 14, for causing storage of the container file, such as in the memory.

An example syntax for the track fragment run metadata is provided below. It needs to be understood that other example embodiments may be realized similarly by realizing some of the features below in a different manner.

aligned(8) class TrackRunBox extends FullBox(‘trun’, version, tr_flags) {

unsigned int(32) sample_count;
// the following are optional fields
signed int(32) data_offset;
unsigned int(32) first_sample_flags;
for (i = 0; i < sample_count; i++)

SampleStruct sample_struct[i];

for (j = 0;;j++) // until the end of the box

RepeatStruct(i) repeat_struct[j];

}
aligned(8) class SampleStruct {// to be replaced by the compacted non-pattern-based

// all fields in the following array are optional
// as indicated by bits set in the tr_flags
{

unsigned int(32) sample_duration;
unsigned int(32) sample_size;
unsigned int(32) sample_flags
if (version == 0)

{ unsigned int(32) sample_composition_time_offset; }

else

{ signed int(32) sample_composition_time_offset; }

}

}
aligned(8) class RepeatStruct(i) {

unsigned int(8) repeat_count; // or configurable length based on box flags
if (repeat_count == 0)

SampleStruct sample_struct[i++];

else {

unsigned int(v) repeat_start; // v determined by i (8-bit when i < 256, 16-bit

when i < 65536, etc.)

unsigned int(8) repeat_period; // or configurable length based on box flags
for (cnt = 0; cnt < repeat_count; cnt++)

for (k = repeat_start; k <= repeat_start + repeat_period; k++)

sample_struct[i++] = sample_struct[k];

}

}

In some embodiments, the track fragment run metadata is a box according to ISOBMFF. In some embodiments, if the duration-is-empty flag is set in the tf_flags, there are no track runs. In some embodiments, a track run documents a contiguous set of samples for a track.

In some embodiments, the number of optional fields is determined from the number of bits set in the lower byte of the flags, and the size of a record from the bits set in the second byte of the flags. This procedure may be followed, to allow for new fields to be defined. If the data-offset is not present, then the data for this run starts immediately after the data of the previous run, or at the base-data-offset defined by the track fragment header if this is the first run in a track fragment, If the data-offset is present, it is relative to the base-data-offset established in the track fragment header.

The following flags may be allowed to be set in the tr_flags:
0x000001 data-offset-present.
0x000004 first-sample-flags-present; this over-rides the default flags for the first sample only. This makes it possible to record a group of frames where the first is a key and the rest are difference frames, without supplying explicit flags for every sample. If this flag and field are used, sample-flags-present may not be set.
sample_count the initial number of samples being added in this run which capture the number of samples with a pattern. When there is no defined cyclic pattern in the samples then the final_sample_count=sample_count; When a cyclic pattern is present in the samples then the final_sample_count is as defined bellow.
data_offset is added to the implicit or explicit data_offset established in the track fragment header.
first_sample_flags provides a set of flags for the first sample only of this run.

In some embodiments, SampleStruct is a structure that captures the per sample metadata. All the fields in the SampleStruct are optional. In some embodiments, the following bits in the tr_flags control the presence of each field in the SampleStruct.
0x000100 sample-duration-present: indicates that each sample has its own duration, otherwise the default is used.
0x000200 sample-size-present: each sample has its own size, otherwise the default is used.
0x000400 sample-flags-present; each sample has its own flags, otherwise the default is used.
0x000800 sample-composition-time-offsets-present; each sample has a composition time offset (e.g., as used for IP/B video in MPEG).

In some embodiments, RepeatStruct is a structure that captures the pattern appearing earlier in the track fragment run. In some embodiments, resolving the cyclic part causes all of the per-sample metadata to be cyclic assignment of the pattern. repeat_count indicates the count of patterns that is appearing earlier in the track fragment run. repeat_start indicates the index of the sample in the track fragment run from which the patterns start. repeat_period indicates the length in terms of no of samples until which the pattern is repeated. final_sample_count is the number of samples being added in this run; When a cyclic pattern is present in the samples then final_sample_count=sample_count+(repeat_count×repeat_period).

In some other example embodiments, a variation of the TrackRunBox with syntax and semantics is provided below:

aligned(8) class TrackRunBox extends FullBox(‘trun’, version, tr_flags) {

unsigned int(32) initial_sample_count;
// the following are optional fields
signed int(32) data_offset;
unsigned int(32) first_sample_flags;
for (int i = 0; i < initial_sample_count;i++){

SampleStruct sample_struct[i];

}
sample_count = initial_sample_count;
// until the end of the box
for (j = 0;;j++){

RepeatStruct repeat_struct[j];

}

}
aligned(8) class SampleStruct( ) {

// all fields in the following array are optional
// as indicated by bits set in the tr_flags
unsigned int(32) sample_duration;
unsigned int(32) sample_size;
unsigned int(32) sample_flags
if (version == 0){

unsigned int(32) sample_composition_time_offset;

}
else{

signed int(32) sample_composition_time_offset;

}

}
aligned(8) class RepeatStruct( ) {

unsigned int(8) repeat_count; // or configurable length based on box flags
if (repeat_count == 0){

SampleStruct sample_struct_sample_count++];

}
else {

// v determined by i (8-bit when i < 256, 16-bit when i < 65536, etc.)
unsigned int(v) repeat_start;
unsigned int(8) repeat_period; // or configurable length based on box flags
unsigned int(8) control_flag;
for (cnt = 0; cnt < repeat_count; cnt++){

for (k = repeat_start; k <= repeat_start + repeat_period; k++){

sample_struct[sample_count] = sample_struct[k];
if(control_flag & 01){

unsigned int(32) sample_struct[sample_count].sample_duration;

}
if(control_flag & 02){

unsigned int(32) sample_struct[sample_count].sample_size;

}
if(control_flag & 03){

unsigned int(32) sample_struct[sample_count].sample_flags;

}
if(control_flag & 04){

if(version==0)

unsigned int(32)

sample_struct[sample_count].sample_composition_time_offset;

else

signed int(32)

sample_struct[sample_count].sample_composition_time_offset;

}
sample_count++;

}

}

}

}

In some embodiments, initial_sample_count indicates the initial number of samples being added in this run which capture the number of samples with a pattern. When there is no defined cyclic pattern in the samples then the sample_count=initial_sample_count; When a cyclic pattern is present in the samples then the sample_count is as defined below. sample_count is the number of samples being added in this run; When a cyclic pattern is present in the samples then sample_count=initial_sample_count+(repeat_count×repeat_period). In some embodiments, RepeatStruct is a structure that captures the pattern appearing earlier in the track fragment run. In some embodiments, resolving the cyclic part causes a subpart of the per-sample metadata to be cyclic assignment of the pattern.

In some embodiments, the presence of the fields in the repeated pattern sampleStruct is controlled by the values of control_flag provided below:
0x01 sample_duration is not part of the pattern and is signalled in the RepeatStruct
0x02 sample_size is not part of the pattern and is signalled in the RepeatStruct
0x04 sample_flags is not part of the pattern and is signalled in the RepeatStruct
0x08 sample_composition_time_offset is not part of the pattern and is signalled in the RepeatStruct

In some embodiments, the syntax and semantics of the TrackRunBox with configurable size is provided herein. Within the TrackFragmentBox, there are zero or more TrackRunBoxes or CompactTrackRunBoxes. If the duration-is-empty flag is set in the tf_flags, there are no track runs. A track run documents a contiguous set of samples for a track. The fields in the array may be configurable by size. If the data-offset-present flag is not present, then the data for this run starts immediately after the data of the previous run, or at the base-data-offset defined by the track fragment header if this is the first run in a track fragment, If the data-offset-present flag is present, it is relative to the base-data-offset established in the track fragment header. The following flags may be allowed to be set in the tr_flags:
0x000001 data-offset-present.
0x000002 first-sample-info-present; this provides specific flags for the first sample; the arrays are then one sample shorter.
0x000004 data_offset_16; indicates the size of the data offset field
0x000008 composition_multiplier_present; if present, indicates that all composition time offsets coded here may be multiplied by the provided composition_multiplier 0x00xx00 field_sizes; indicates the size of fields:
   unsigned int(2) duration_size_index;
   unsigned int(2) sample_size_index;
   unsigned int(2) flags_size_index;
   unsigned int(2) composition_size_index;
0xyy0000 first_field_sizes; indicates the size of first_sample fields:
   unsigned int(2) first_duration_size_index;
   unsigned int(2) first_sample_size_index;
   unsigned int(2) first_flags_size_index;
   unsigned int(2) first_composition_size_index;

When first_sample_info_present is set, then the supplied or defaulted values for the first sample differ from the rest of the samples. For any field, if the size indication is zero, the field is absent and the usual defaulting applies (to values supplied in the TrackFragmentHeaderBox or TrackExtendsBox, or to 0 in the case of composition offsets). The composition offset values in the CompositionOffsetBox and in the TrackRunBox may be signed or unsigned. The recommendations given in the CompositionOffsetBox concerning the use of signed composition offsets also apply here. In the (common) case that composition offsets are all multiples of a base value, that base value can be supplied and only the multipliers coded for each sample.

In some embodiments, when the sample flags are encoded in less than 32 bits, the provided bytes start with the high-order bits of the field (starting with the reserved 4 bits, and following with is_leading etc.), not the low-order bits. Bits not present are assumed to take the value zero. An example syntax is provided below:

unsigned int(8) function f(unsigned int(2) index) {

switch(index) {

case 0: return 0;
case 1: return 8;
case 2: return 16;
case 3: return 32;

}
aligned(8) class CompactTrackRunBox

extends CompactFullBox(‘ctrn’, version, tr_flags) {

// all index fields take value 0,1,2,3 indicating 0,1,2,4 bytes
unsigned int(16) initial_sample_count;
if (tr_flags & data_offfset_present) {

if (tr_flags & data_offset_16) {

signed int(16) data_offset;

}
else {

signed int(32) data_offset;

}

}
if (tr_flags & composition_multiplier_present){

unsigned int(16) composition_multiplier;

}
if (first_sample_info_present) {

// all the following are effectively optional
// as the field sizes can be zero
unsigned int(f(first_duration_size_index))

fist_sample_duration;

unsigned int(f(first_sample_size_index))

first_sample_size;

unsigned int(f(first_flags_size_index))

first_sample_flags;

if (version == 0)

{ unsigned int(f(composition_size_index))

first_sample_composition_time_offset; }

else

{ signed int(f(composition_size_index))

first_sample_composition_time_offset; }

}

}
// the following is a local variable, not a field in the structure
int array_size = initial_sample_count − (first_sample_info_present ? 1 : 0);

for (int i = 0; i < array_size;i++){

SampleStruct sample_struct[i];

}
sample_count = initial_sample_count;
// until the end of the box
for (j = 0;;j++){
RepeatStruct repeat_struct[j];

```
  }
  }
```

```
aligned(8) class SampleStruct( ) {
  // all fields in the following array are optional
  // as indicated by bits set in the tr_flags
```

// all the following arrays are effectively optional
// as the field sizes can be zero
unsigned int(f(duration_size_index))

sample_duration;

unsigned int(f(sample_size_index))

sample_size;

unsigned int(f(flags_size_index))

sample_flags;

if (version == 0){

unsigned int(f(composition_size_index))

sample_composition_time_offset;

}
else{

signed int(f(composition_size_index))

sample_composition_time_offset;

}

```
}
aligned(8) class RepeatStruct( ) {
  unsigned int(8) repeat_count; // or configurable length based on box flags
  if (repeat_count == 0){
```

SampleStruct sample_struct[array_size++];

sample_count++;

}
else {

// v determined by i (8-bit when i < 256, 16-bit when i < 65536, etc.)
unsigned int(v) repeat_start;
unsigned int(8) repeat_period; // or configurable length based on box flags
unsigned int(8) control_flag;
for (cnt = 0; cnt < repeat_count; cnt++){

for (k = repeat_start; k <= repeat_start + repeat_period; k++){

```
  sample_struct[array_size] = sample_struct[k];
  if(control_flag & 01){
```

unsigned int(f(duration_size_index))

sample_struct[array_size].sample_duration;

```
  }
  if(control_flag & 02){
```

unsigned int(f(sample_size_index))

sample_struct[array_size].sample_size;

```
  }
  if(control_flag & 03){
```

unsigned int(f(flags_size_index))

sample_struct[array_size].sample_flags;

```
  }
  if(control_flag & 04){
```

if(version==0)

unsigned int(f(composition_size_index))

sample_struct[array_size].sample_composition_time_offset;

else

signed int(f(composition_size_index))

sample_struct[array_size].sample_composition_time_offset;

```
  }
array_size++;
  sample_count++;
}
```

}

}

}

duration_size_index, flags_size_index, composition_size_index and the corresponding first field indexes indicate the size of the corresponding field, with the value 0 indicating the field is absent, the values 1,2 indicating a field size equal to that number of bytes, and the value 3 indicating a field size of 4 bytes. sample_count indicates the number of samples being added in the track run. data_offset is added to the implicit or explicit data_offset established in the track fragment header.

In some instances, some syntax element values of track fragment run metadata is the same in multiple tracks. For example, for tile or sub-picture tracks that originate from the same video bitstream and/or are merged to the same video bitstream by a file writer or alike, values of sample duration, sample flags, and sample composition time offset in tile-aligned samples of the tile or sub-picture tracks and in the respective tile base or extractor tracks (if present) are likely to be the same. An example embodiment enables inheritance of track fragment run fields across tracks and is discussed below. This embodiment may be used together with or independently of other embodiments for compacting track fragment runs within a track.

In some embodiments, a track reference type (e.g., ‘trin’) is specified to indicate that the containing track may inherit TrackRunBox or CompactTrackRunBox contents from the track pointed to by the specific track reference type. Only one entry may be allowed in the track reference of the specific type. An indication is specified to indicate if inheritance of TrackRunBox/CompactTrackRunBox contents is used. For example, a box flag of the TrackRunBox/CompactTrackRunBox whether the box content is inherited.

Indications may be present per syntax element indicative of whether that syntax element is inherited or present in the TrackRunBox/CompactTrackRunBox. Alternatively, it may be pre-defined, e.g., in a file format standard, one or more fields that are inherited (subject to the indication discussed above indicating that inheritance across tracks takes place) and which are present. For example, sample size field may be present in the TrackRunBox/CompactTrackRunBox, whereas other fields may be inherited.

In some embodiments, the following box flag may be used for indicating inheritance:

0x000004 (e.g., hexadecimal value 4) is defined either as data_offset_16 (when data_offset_present is equal to 1) indicates the size of the data offset field, or as data_inherited_flag (if data_offset_present is equal to 0), which when equal to 1, indicates that the track run data is inherited from the time-aligned track run of the track pointed to by the ‘trin’ track reference.

In some embodiments, by way of example, the following syntax may be used:

aligned(8) class CompactTrackRunBox

extends FullBox(‘ctrn’, version, tr_flags) {

if ((tf_flags & data_offset_present) ∥

!(tf_flags & data_inherited_flag)) {
... // the previous content of CompactTrackRunBox unchanged

}

}

In some embodiments, inheritance of syntax element values within a track run is performed as follows. RepeatStruct structures are included at the end of the previously design of TrackRunBox or CompactTrackRunBox. The number of RepeatStruct structures is determined by a file writer. The RepeatStruct is summarized as follows:
The TrackRunBox or CompactTrackRunBox contains another RepeatStruct structure if the end of the box has not been reached yet. The function EndOfBox( ) returns 0, if the end of the box has not been reached yet, and returns 1 otherwise.
Each RepeatStruct contains:
   The number of times a pattern is repeated (repeat_count_minus1+1)
   A starting sample index within the track run (repeat_start)
   The length of the pattern (repeat_period_minus1+1)
The values of syntax elements are either copied from the sample in the pattern or is present, as controlled in RepeatStruct. For example, the structure can only have sample sizes present and inherent all other syntax element values. When present in the structure, the syntax element length can be indicated to be 8, 16, or 32 bits or some other predefined length of bits. When the syntax element length is indicated to be 0 bits, it is inherited as controlled by the RepeatStruct.

In some embodiments, the following syntax is used to combine inheritance across tracks and within a track run. It needs to be understood that the either inheritance across tracks and within a track run could be used as an embodiment independently of the other part. Similar embodiments could be realized with other syntax options.

aligned(8) class CompactTrackRunBox

extends FullBox(‘ctrn’, version, tr_flags) {

if ((tf_flags & data_offset_present) ∥

!(tf_flags & data_inherited_flag)) {
... // the previous content of CompactTrackRunBox unchanged
while (!EndOfBox( ))

RepeatStruct( );

}

}
aligned(8) class RepeatStruct( ) {

unsigned int(8) repeat_count_minus1;
if(sample_count < 256) rs_len = 8;
else if (sample_count < 65536) rs_len = 16;
else rs_len = 32;
unsigned int(rs_len) repeat_start;
unsigned int(7) repeat_period_minus1;
unsigned int(1) exp_size_idx_flag;
if( exp_size_idx_flag ) {

unsigned int(2) dur_size_idx;
unsigned int(2) siz_size_idx;
unsigned int(2) fgs_size_inx;
unsigned int(2) cto_size_idx;

}
else {

// values inferred
dur_size_idx = 0;
siz_size_idx = sample_size_index;
fgs_size_inx = 0;
cto_size_idx = 0;

}
for (cnt = 0; cnt <= repeat_count_minus1; cnt++){

for (i = 0; i <= repeat_period_minus1; i++ ) {

// function f( ) specified further above
unsigned int(f(dur_size_idx)) exp_sample_duration;
unsigned int(f(siz_size_idx)) exp_sample_size;
unsigned int(f(fgs_size_idx)) exp_sample_flags;
if (version == 0)

unsigned int(f(cto_size_idx)) exp_sample_duration;

else

signed int(f(cto_size_idx)) exp_sample_duration;

}
sample_count += repeat_period_minus1 + 1;

}

}

dur_size_idx and fgs_size_idx may be similar to duration_size_index and flags_size_index previously described.

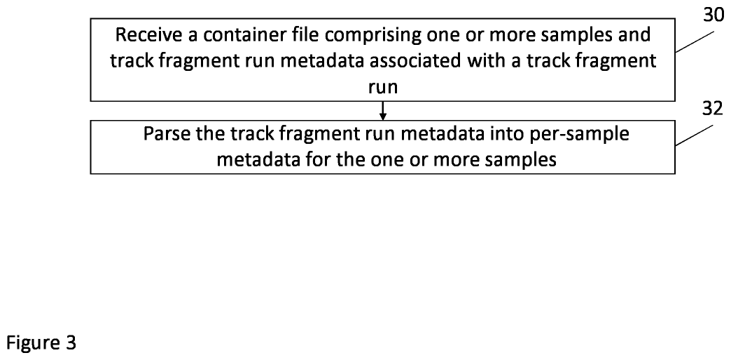

FIG. 3 illustrates the process of decoding track fragment run metadata performed by, for example, a file reader, a decoder, or the like that may be embodied by apparatus 10 of FIG. 1. As illustrated in block 30, an apparatus, such as apparatus 10 of FIG. 1, includes means, such as the processing circuitry 12, for receiving a container file comprising one or more samples and track fragment run metadata associated with a track fragment run. The track fragment run metadata includes a per-sample part comprising per-sample metadata for each sample in the container file and a cyclic part. The track fragment run metadata further comprises indication of a pattern appearing earlier in the track fragment run and resolving the cyclic part causes at least a subset of the per-sample part to be set by cyclic assignment of the pattern indication of a pattern appearing earlier in the track fragment run. The track fragment run metadata may be generated by the apparatus. Details regarding the track fragment run metadata have been previously described.

As illustrated in block 32, an apparatus, such as apparatus 10 of FIG. 1, includes means, such as the processing circuitry 12 and the memory 14, for parsing the track fragment run metadata into per-sample metadata for the one or more samples.

At least some embodiments of the present disclosure provide the advantage of reducing byte count overhead because cyclically repeated metadata are transmitted only once rather than repeatedly for each sample.

Certain example embodiments have been described with reference to tile tracks and tile base tracks. It is to be understood that other embodiments could be similarly realized with other similar concepts, such as sub-picture tracks and extractor tracks rather than tile tracks and tile base tracks, respectively.

Certain example embodiments have been described in relation to specific syntax. It should be understood that other embodiments apply similarly to other syntax with the same or similar functionality.

Certain example embodiments have been described in relation to specific syntax. It should be understood that other embodiments apply to an entity writing such syntax. For example, where an embodiment is described in relation to file format syntax, other embodiments also apply to a file writer creating a file or segment(s) according to the file format syntax. Similarly, at least some embodiments apply to an entity reading such syntax. For example, where an embodiment is described in relation to file format syntax, other embodiments also apply to a file reader parsing or processing a file or segment(s) according to the file format syntax.

An example embodiment described above describes the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe certain embodiments performed by a codec within an apparatus, it would be appreciated that other embodiments may be implemented as part of any video codec. Thus, for example, certain embodiments may be implemented in a video codec which may implement video coding over fixed or wired communication paths.

As described above, FIGS. 2 and 3 include flowcharts of an apparatus 10, method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 14 of an apparatus employing an embodiment of the present disclosure and executed by processing circuitry 12 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowcharts of FIGS. 2 and 3. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
encoding, into a container file comprising one or more samples, track fragment run metadata associated with a track fragment run, comprising:
a per-sample part comprising per-sample metadata for one or more samples in the container file,
a cyclic part, wherein the track fragment run metadata comprises an indication of a pattern appearing earlier in the track fragment run, and wherein resolving the cyclic part causes at least a subset of the per-sample part to be set by cyclic assignment of the pattern indication of a pattern appearing earlier in the track fragment run; and
causing storage of the container file.

2. The method according to claim 1, wherein the encoding further comprises encoding a subset of one or more per-sample metadata fields as set by cyclic assignment of the pattern.

3. The method according to claim 1, wherein the track fragment run metadata is a box according to International Standard Organization media file format.

4. The method according to claim 1, wherein the track fragment run metadata comprises a duration-is-empty flag indicating presence of no track runs.

5. The method according to claim 1, wherein the track fragment run metadata is associated with a track that comprises one or more track fragment runs.

6. The method according to claim 5, wherein each track fragment run documents a contiguous set of samples for the track.

7. An apparatus comprising at least one processor and at least one memory including computer program code for one or more programs, the at least one memory and the computer program code configured to, with the at least one processor, cause the apparatus at least to:
receive a container file comprising one or more samples and a track fragment run metadata associated with a track fragment run, comprising:
a per-sample part comprising per-sample metadata for one or more samples in the container file,
a cyclic part, wherein the track fragment run metadata comprises an indication of a pattern appearing earlier in the track fragment run, and wherein resolving the cyclic part causes at least a subset of the per-sample part to be set by cyclic assignment of the pattern indication of a pattern appearing earlier in the track fragment run; and
parse the track fragment run metadata into per-sample metadata for the one or more samples.

8. The apparatus according to claim 7 wherein the parsing further comprises parsing a subset of one or more per-sample metadata fields as set by cyclic assignment of the pattern.

9. The apparatus according to claim 7, wherein the track fragment run metadata is a box according to International Standard Organization media file format.

10. The apparatus according to claim 7, wherein the track fragment run metadata comprises a duration-is-empty flag indicating presence of no track runs.

11. The apparatus according to claim 7, wherein the track fragment run metadata is associated with a track that comprises one or more track fragment runs.

12. The apparatus according to claim 11, wherein each track fragment run documents a contiguous set of samples for the track.

13. An apparatus comprising at least one processor and at least one memory including computer program code for one or more programs, the at least one memory and the computer program code configured to, with the at least one processor, cause the apparatus at least to:
encode, into a container file comprising one or more samples, track fragment run metadata associated with a track fragment run, comprising:
a per-sample part comprising per-sample metadata for one or more samples in the container file,
a cyclic part, wherein the track fragment run metadata comprises an indication of a pattern appearing earlier in the track fragment run, and wherein resolving the cyclic part causes at least a subset of the per-sample part to be set by cyclic assignment of the pattern indication of a pattern appearing earlier in the track fragment run; and
cause storage of the container file.

14. The apparatus according to claim 13 wherein the encoding further comprises encoding a subset of one or more per-sample metadata fields as set by cyclic assignment of the pattern.

15. The apparatus according to claim 13, wherein the track fragment run metadata is a box according to International Standard Organization media file format.

16. The apparatus according to claim 13, wherein the track fragment run metadata comprises a duration-is-empty flag indicating presence of no track runs.

17. The apparatus according to claim 13, wherein the track fragment run metadata is associated with a track that comprises one or more track fragment runs.

18. The apparatus according to claim 17, wherein each track fragment run documents a contiguous set of samples for the track.
